(19) United States
(12) Patent Application Publication
(10) Pub. No.: US 2009/0193693 A1
(43) Pub. Date: Aug. 6, 2009

(54) Eco-friendly name badges and picture frames

(76) Inventor: Eduardo E. Drake, Golden Valley, MN (US)

Correspondence Address: SCHWEGMAN, LUNDBERG & WOESSNER, P.A., P.O. BOX 2938, MINNEAPOLIS, MN, 55402, US

(21) Appl. No.: 12/154,476

(22) Filed: May 23, 2008

Related U.S. Application Data
(60) Provisional application No. 60/931,536, filed on May 23, 2007.

(51) Int. Cl. A44C 3/00; G06Q 30/00

(52) U.S. Cl. 40/1.5; 705/26

(57) ABSTRACT

Various embodiments of name badge assemblies and picture frame assemblies are shown. A simple card clip structure may also be obtained providing a paper or plastic card and die cutting a U-shaped slot in a horizontal or vertical orientation. A tongue portion defined within between the legs of the U-shaped slot flexes to receive and retain papers and hold bags secure. The card may be printed with promotional information.

### RELATED APPLICATIONS

This application claims priority to U.S. provisional application 60/931,536, which was filed on May 23, 2007. This application is incorporated herein by reference.

### COPYRIGHT NOTICE AND PERMISSION

A portion of this patent document contains material subject to copyright protection. The copyright owner has no objection to the facsimile reproduction by anyone of the patent document or the patent disclosure, as it appears in the Patent and Trademark Office patent files or records, but otherwise reserves all copyrights whatsoever. The following notice applies to this document: Copyright® 2007, 2008 Eduardo E. Drake.

### TECHNICAL FIELD

Various embodiments of the present invention concern name badges, particularly name badge holder assemblies.

### BACKGROUND

The present inventor recognized that conventional name badges suffer from a number of problems. For example, some conventional name badges comprise adhesive labels. The adhesive of these labels can damage clothing of users or do not adhere or stick well to the full range of clothing fabrics that users wear. In the case of poorly sticking labels, users suffer the annoyance of continually retrieving and reapplying fallen labels. Moreover, the adhesive, in some instances, may not be environmentally friendly to produce or to dispose. A significant portion of conventional name badges comprise a paper name card inserted into a transparent vinyl or plastic carrying sleeve. The sleeve typically has a spring clip or pin to allow fasten the sleeve to clothing, or holes for mounting a lanyard that can be worn around the neck of a user. Unfortunately, neither the sleeve nor the spring clip is readily biodegradable. Moreover, the vinyl or plastic sleeve is fairly reflective and can produce glare which may make the name card difficult to read in some circumstances.

Accordingly, the present inventor has identified a need for alternative name badges.

### BRIEF DESCRIPTION OF DRAWINGS

FIGS. 1A and 1B show respective front and back view of an exemplary name badge assembly 100.

FIGS. 1C and 1D show respective profile views of name-bade assembly 100 installed on a pocket 120 or a shirt or blouse button 130.

FIGS. 2A and 2B are plan and profile views of another exemplary badge assembly.

FIGS. 3A and 3B are plan and profile views of another exemplary badge assembly corresponding to one or more embodiments of the invention.

FIGS. 5, 6, and 7 are views corresponding to one or more other embodiments of the invention.

FIGS. 8A, 8B, and 8C are views corresponding to one or more embodiments of the invention.

FIGS. 9A and 9B are views corresponding to one or more other embodiments of the invention.

FIGS. 10A, 10B, and 10C are views corresponding to one or more embodiments of the invention.

FIG. 11 is a flow chart of an exemplary method corresponding to one or more embodiments of the invention.

### DETAILED DESCRIPTION OF EXEMPLARY EMBODIMENTS

This description describes and/or illustrates one or more specific embodiments of one or more inventions. These embodiments, offered not to limit but only to exemplify and teach the invention, are shown and described in sufficient detail to enable those skilled in the art to implement or practice the invention. Thus, where appropriate to avoid obscuring the invention(s), the description may omit certain information known to or ascertainable without undue experimentation by those of skill in the art.

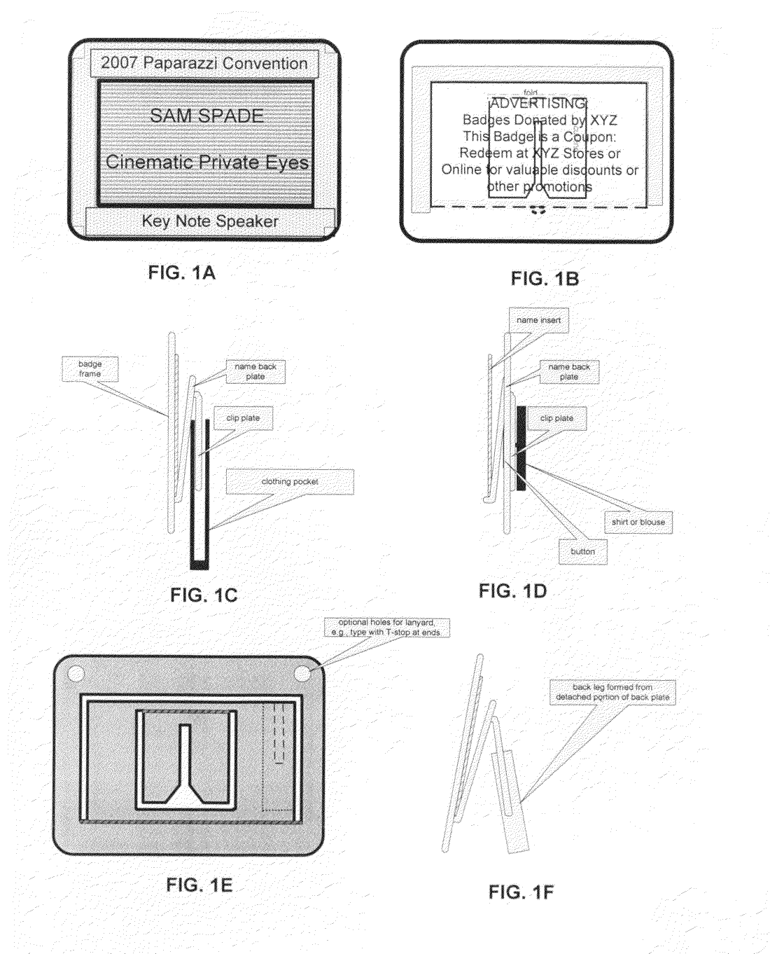

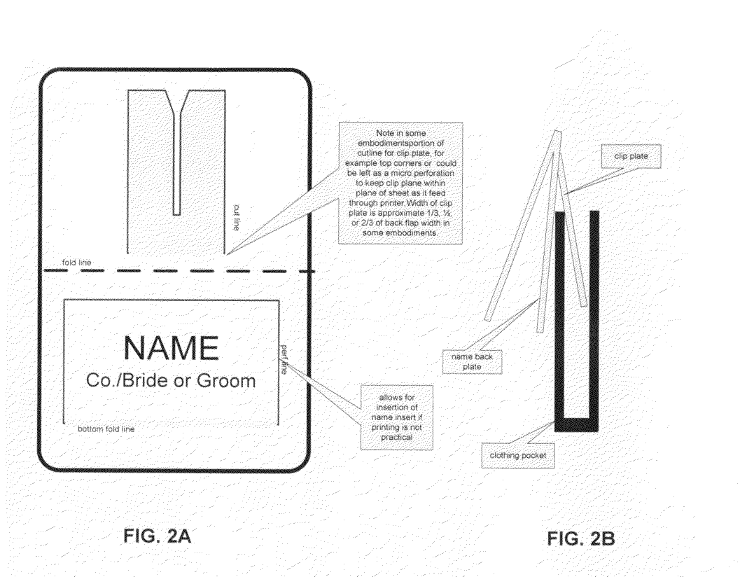

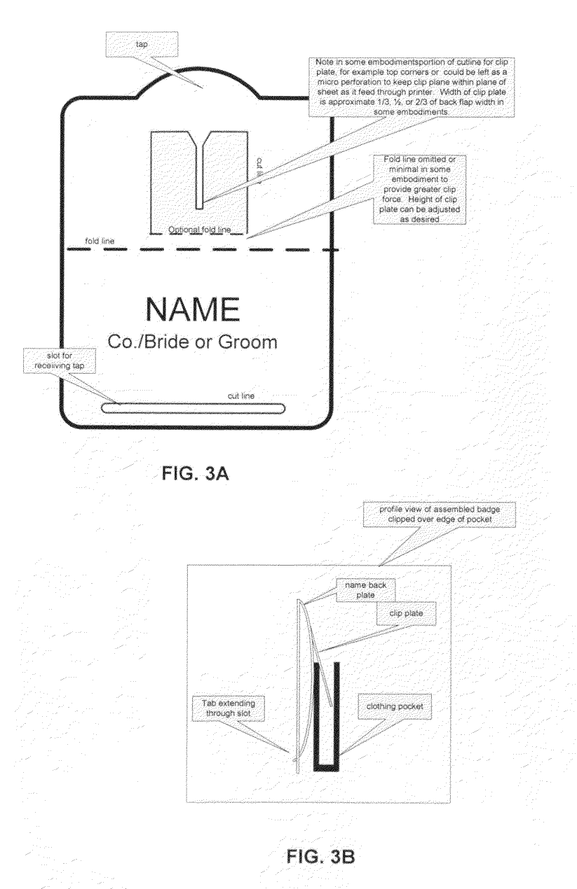

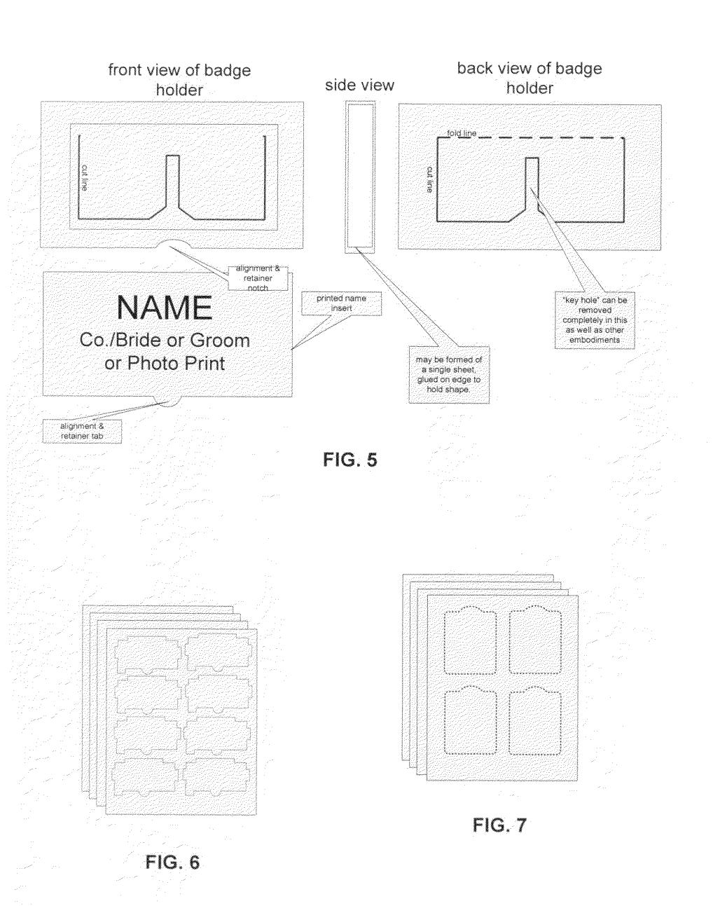

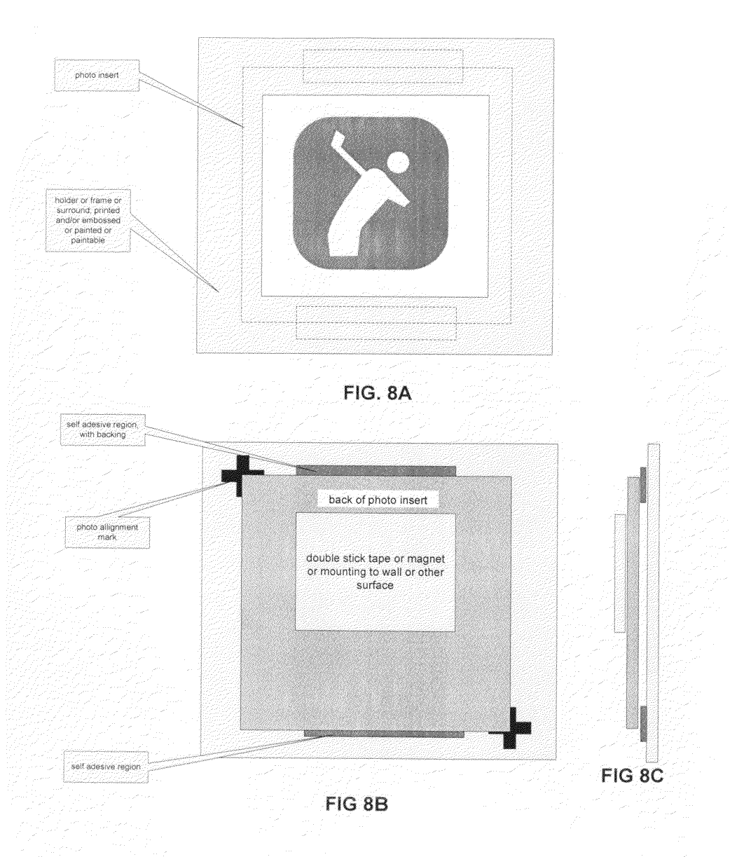

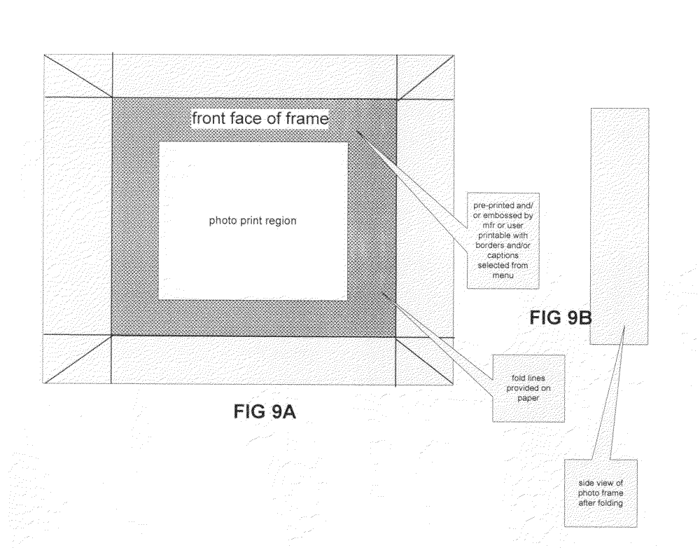

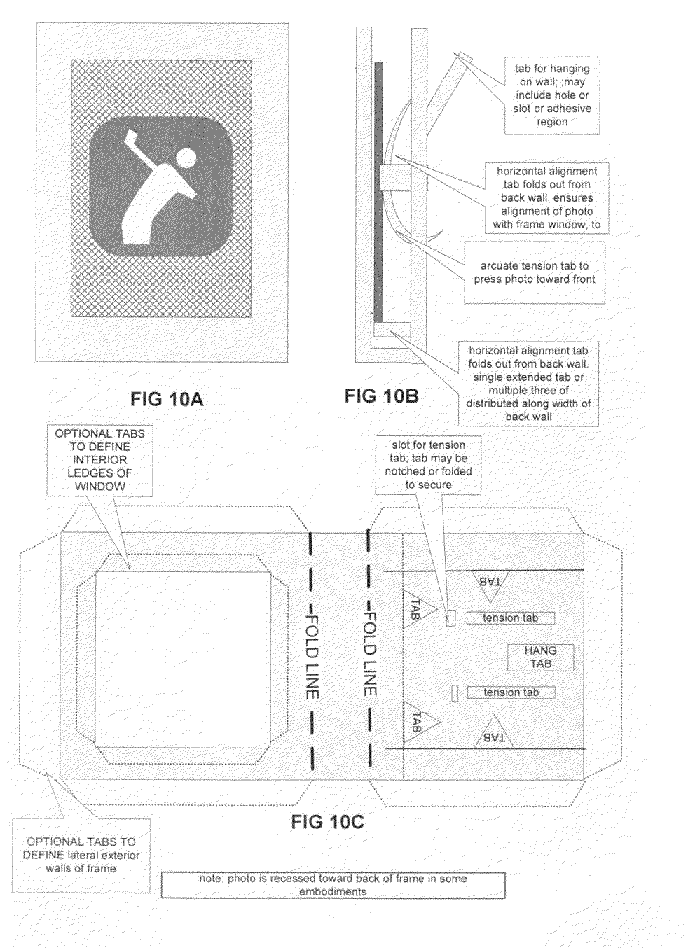

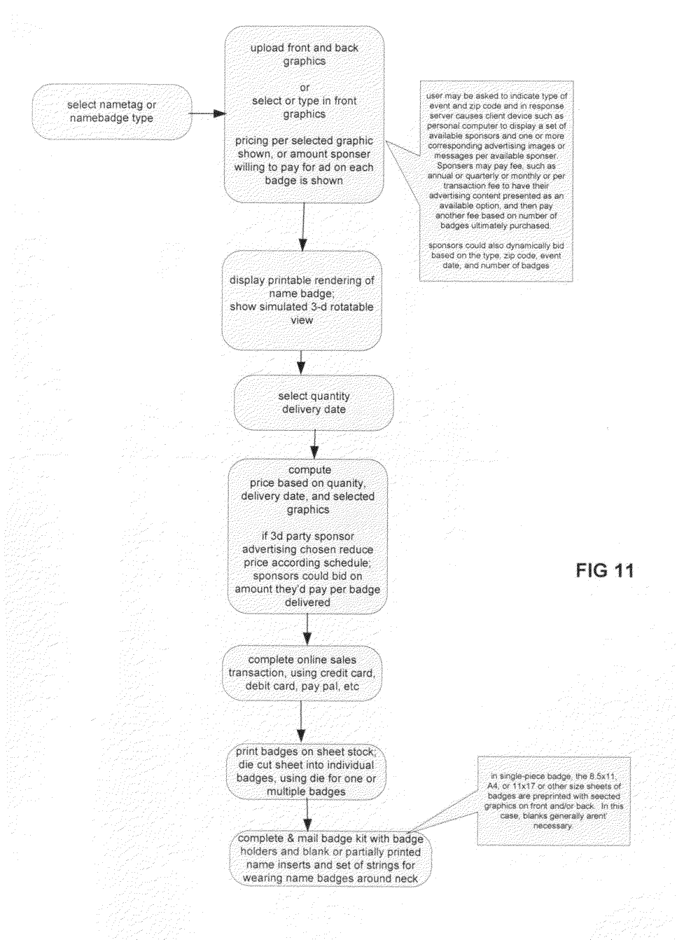

FIGS. 1A and 1B show respective front and back view of an exemplary name-badge (or frame) assembly 100. Assembly 100 includes a badge holder 110 and a name plate 120, both of which have a generally rectangular shape in the exemplary embodiment.

In particular, FIG. 1A shows that badge holder 110 (or badge frame) includes left and right vertical frame portions 111A and 111B and top and bottom horizontal frame portions 111C and 111D. In the exemplary embodiment, one or more of frame portions 111A-111D are marked with printed, embossed, and/or holographic images, such as an event or sponsor name, etc. Frame portions 111A-111D also define a rectangular frame opening or window 112, which frames and exposes a front printed or image-bearing portion 122 of name plate (or insert) 120. (In some embodiments, both sides of name plate 120 bears or carries textual and/or graphic information. For example, in some of these embodiments, the back side of the name plate includes sponsor promotional messages, one or more coupons, and/or related serial numbers or bar codes. Front portion may also include bar codes or serial numbers.)

FIG. 1B, the back view, shows that badge holder 110 includes a back plate portion 114 that captures and holds name plate 120 between the back plate and frame portions 111. More particularly, back plate portion 114, which corresponds to the precise shape of frame opening 112, includes left and right vertical edges 112L, 112R, and top horizontal edge 112T. A bottom edge or boundary 112B of black plate portion 114 is defined by a fold or crease line, which supports a bottom edge of name 120. The fold or crease line is perforated and/or embossed in some embodiments, and defines a rotational axis for rotating or folding back plate portion 114 relative to frame portions 111. Formed in an interior region of back plate portion 114 is clip plate portion 116.

In some embodiments, advertisings on the name badge holder takes form of discount, e.g., two coffees, entrees, etc. for price of one, to generate retail or web traffic to sponsors. In some embodiments, convention halls and conference or banquet centers provide name tags free to booking organizations and sell advertising space to business, such as local bars and restaurants.

Clip plate portion 116 includes left and right vertical edges or boundaries 116L, 116R, and bottom horizontal edge 116B. A top edge or boundary 116T of clip plate portion 116 is defined by a fold or crease line, which is perforated and/or embossed in some embodiments, and defines a rotational axis for rotating or folding clip plate portion 116 relative to back plate portion 114 to engage a button. Additionally, clip plate portion 116 includes button hole slot 118 for engaging shirt pocket 120 or button 130 as shown best in the profile views of FIGS. 1C and 1D. Lower outwardly tapered or flared portion 118F facilitates engagement of slot 118 with button threads. Some embodiments rotate button hole slot 118 45, 90, or 180 degrees relative to top fold line 116T. Some embodiments include clip plates with two slots, parallel to each other or one transverse to the other.

FIG. 1E shows that in some embodiments, edges 112L, 112R, and 112T are formed using a die, laser, or mill cut to create a generally downwardly oriented U-shaped slot 130 that provides clearance between interior edges of frame portions 111 and exterior edges of back plate 114. Similarly, edges 116L, 116R, and 116B define a generally upwardly oriented U-shaped 140.

FIG. 1F shows that the assembly 100 is sized to receive a standard-sized photographic print, such as wallet (for example, 2.5×3.5), 4″×5″; 4″×6″; 6″×8″; 5″×7″; 8″×10″; 8″×12″; 8½″×11″; 9″×12″; 10″×13″; 11″×14″; 12″×16″; 14″×18″; 16″×20″; 20″×24″; 22″×28″; 24″×30″. In these cases, a side portion of back plate 114 includes a vertical and horizontal perforations and a vertical slot which allow a user to easily remove a portion of the back plate (see back plate in FIG. 1E), rotate the removed portion about its longitudinal axis, and reattach the removed portion to the clip plate by engaging its slot with the slot of the clip plate, thereby extending the length of the clip plate portion and transforming it to a supporting back leg 150. The back leg allows the assembly to be stood up on its bottom edge as a free standing picture frame. Also, in some embodiments, the top fold line of the clip plate is at the bottom, allowing the clip plate to function as a back leg. Other embodiments may include a double stick tape that allows the assembly including the photo insert to be adhered to a wall of a building or cubical or other surface. Still other embodiments include self-adhesive regions on the back of the name badge holder, for example, to further secure name plate or photos in place.

In the exemplary embodiment, front and back views are identical with exception of graphical content; side views are identical and top and bottom views are identical (when no insert is present). Fold lines and cut lines (crease lines) and outer edges are formed preferably using a die cutter, with multiple cards cut from pre-printed card stock or paper. In some embodiments, the one or both of the top and bottom fold lines are rotated 90 degrees. Peripheral shape of holder can be varied to allow for more detailed branding. For example, sunburst could be allowed to bleed off of one corner region. Some embodiment use a sheet of vinyl or plastic, such as corn-based plastic to form this or other badge holders shown herein.

add holes to upper portion of back plate or upper portion of frame to allow for hanging with string.
alternative embodiment would have a flattened cardstock or cardboard sleeve open on at least one end, preferably both, with window one side to allow viewing of name insert and hinged clip plate as shown herein with optional button slot. Back panel of flattened sleeve would have holes for sleeve could be glued on seam or fastened with tabs and lots

### CONCLUSION

The embodiments described above are intended only to illustrate and teach one or more ways of practicing or implementing the present invention, not to restrict its breadth or scope. The actual scope of the invention, which embraces all ways of practicing or implementing the teachings of the invention, is defined only by the issued claims and their equivalents.

What is claimed is:

1. A name badge assembly comprising:
a badge holder comprising a generally planar card having first and second major surfaces defining a nominal thickness of the card and bounded by a peripheral card edge, the card having a first integrally hinged flap defined by a generally U-shaped cutline or perforation pattern through the paper card and a fold line or crease in the second major surface to facilitate angular rotation of the flap about the fold line or crease or relative to a peripheral edge of the card.

2. The name badge assembly of claim 1, wherein the card consist essentially of one of a paper-based card stock, a recycled plastic, a pulp paper, recycled corrugated cardboard, and recycled vinyl or a combination thereof.

3. The name badge assembly of claim 1, wherein the card comprises a 2-dimensional or three-dimensional holographic image.

4. The name badge assembly of claim 1, wherein the first or second major surface is marked with abar code or serial number or wherein the card includes an embedded RFID (radio frequency identification tag).

5. The name badge assembly of claim 1, wherein one or more of the first and second major surfaces is marked with advertising from a third-party sponsor, wherein the third-party sponsor has paid an advertising or promotional fee to a manufacturer, distributor, purchaser, or wearer of the badge holder.

6. The name badge assembly of claim 1, further comprising a name insert for insertion between a front portion of the hinged flap and the first major surface, wherein the name insert is marked with the name of an individual.

7. A method of distributing name badge, comprising:
Receiving orders for name badges via an internet connection; and
Providing the ordered name badges for a discount or free of charge in exchange for the name badges having third-party advertising content from one or more third-party sponsor.
